(19) United States
(12) Patent Application Publication
(10) Pub. No.: US 2025/0161860 A1
(43) Pub. Date: May 22, 2025

(54) Device for Filtering Air Intended to Supply An Air System Of A Transport Vehicle System Comprising Such Device And Method For Manufacturing Such A Filtering Device

(71) Applicants: LIEBHERR-AEROSPACE TOULOUSE SAS, Toulouse (FR); SAINT-GOBAIN CENTRE DE RECHERCHES ET D'ETUDES EUROPEEN, COURBEVOIE (FR)

(72) Inventors: Phillippe Heraud, Toulouse (FR); Lamia Creibine, Toulouse (FR); Jerome Jacquart, Toulouse (FR); Patrick Nguyen Van Nuci, Vedeme (FR); Lucas Giardella, Avignon (FR)

(73) Assignee: LIEBHERR-AEROSPACE TOULOUSE SAS, Toulouse (FR)

(21) Appl. No.: 18/034,355

(22) PCT Filed: Oct. 26, 2021
(86) PCT No.: PCT/EP2021/079645

§ 371 Date: Apr. 27, 2023

(30) Foreign Application Priority Data
Oct. 27, 2020 (FR) FR2011007

(51) Int. Cl. B01D 53/04; B01D 29/00; B64D 13/06

(52) U.S. Cl. CPC B01D 53/0407; B01D 29/0093; B01D 2253/102; B01D 2253/1085; B01D 2253/204; B01D 2253/311; B01D 2257/90; B01D 2258/06; B64D 2013/0651

(57) ABSTRACT

Device (50) for filtering air intended to supply an air system of an airborne, rail-bound or automotive transport vehicle, characterized in that it comprises a porous three-dimensional structure (52) comprising at least one portion intended to be in contact with said air to be filtered, referred to as exchange portion (53), said exchange portion (53) comprising at least one adsorbent material in the form of particles selected from carbon, a zeolite, a metal organic framework and mixtures thereof, said adsorbent particles being bound by a binder, said binder comprising at least one material selected from the group formed of boehmite, hydrated aluminas, transition aluminas and mixtures thereof.

### TECHNICAL FIELD OF THE INVENTION

The invention relates to a device for filtering pollutants, in particular oily aerosols and olfactive compounds, present in air intended to supply an air system of an airborne, rail-bound or automotive transport vehicle, such as an air-conditioning system. The invention also relates to an air system, in particular an air-conditioning system of an airplane cabin, equipped with such a filtering device.

### TECHNOLOGICAL BACKGROUND

An air-conditioning system of a transport vehicle is designed to draw in air from outside the transport vehicle, to condition this air and to deliver this air to the inside of the transport vehicle. For example, an air-conditioning system of an airplane cabin is intended to supply pressure-controlled and/or temperature-controlled air to the cabin (which generally means any internal space of the airplane in which the pressure and/or temperature must be controlled, such as the passenger cabin, the pilot cockpit, a hold, etc.).

An air-conditioning system of an airplane generally comprises, in a known manner, a compressed air-drawing device on at least one compressor of an engine of the airplane (such as for example a propulsion engine or auxiliary engine of the airplane also known as auxiliary power unit (APU), or even from a high-pressure system on-board a truck on the ground for ground maneuvers of the airplane). This compressed air is generally referred to as “bleed air”.

Bleed air is thus, in terms of the invention, air which comes directly from the air-drawing device, i.e. generally a compressor of a propulsion engine of the airplane or a compressor of an auxiliary power unit, or air coming directly from a compressor compressing the external air, as used in an electric air-conditioning system.

Such a known air-conditioning system also comprises an air-cycle turbomachine comprising at least one compressor and one turbine mechanically coupled to each other, said compressor comprising an air inlet connected to said compressed air-drawing device and an air outlet, and said turbine comprising an air inlet and an air outlet connected to said cabin in order to be able to supply pressure-controlled and temperature-controlled air to the cabin.

Throughout the text, the term “turbine” refers to a rotating device intended to use the kinetic energy of the air in order to bring about rotation of a shaft supporting the blades of the turbine. The term “compressor” refers to a rotating device intended to increase the pressure of the air which it receives at the inlet.

The bleed air contains pollutants such as oily aerosols, i.e. particles suspended in the air originating from the lubricants or oils used in the propulsion engine or auxiliary engine as the case may be.

Nowadays, air-conditioning systems commonly use ozone converters which take the form of a catalytic cartridge configured to remove ozone and pollutants from the air before said air is supplied to the cabin. Also, in order to remove the pollutants of the oily aerosol type, the converter may be equipped with a redox device which permits on the one hand the reduction of ozone and on the other hand the oxidation of some pollutants. However, this device is not suitable for all the pollutants contained in the compressed air and is not sufficiently effective for engine oils.

Consequently, the pollutants of the oily aerosol type used in the propulsion or auxiliary engines of the airplane may end up in the air supplying the inside of the airplane, such as for example the cabin, and thus cause unpleasant odors for the passengers.

The inventors have thus sought to develop a novel solution for purifying/decontaminating the air supplying the inside of an airplane whilst allowing the equipment of the air-conditioning system to be retained.

The inventors have in particular sought to propose a solution which can be implemented not only within the scope of air-conditioning systems of a transport vehicle, such as an airplane, but also in all types of air systems of an airborne, rail-bound or automotive transport vehicle, requiring the processing of air contaminated by pollutants of the oily aerosol type, before being distributed to an air consumer. By way of non-limiting example, it can be a system for supplying air to a fuel cell, a tank inerting system, a vapor cycle cooling system, etc.

### AIMS OF THE INVENTION

The invention aims to provide a filtering device which allows the capturing of pollutants, in particular oily aerosols and olfactive compounds, present in the air intended to supply an air system, such as for example an air-conditioning system of an airborne, rail-bound or automotive transport vehicle.

The invention aims to provide in particular a filtering device which contributes to overcoming at least some of the disadvantages of the known solutions.

The invention also aims to provide, in at least one embodiment, a filtering device which is small in size and allows in particular a large amount of pollutants to be adsorbed in a small space.

The invention also aims to provide an air-conditioning system which contributes to processing the air supplying the cabin of an airplane so as to counteract the annoyance of bad smells associated with the problems of fumes causing odors which are unpleasant for passengers.

The invention also aims to provide, in at least one embodiment, an air-conditioning system which contributes to preventing the deactivation of the ozone converters.

The invention also aims to provide a method for manufacturing an air-filtering device intended to be mounted in an air system of an airborne, rail-bound or automotive transport vehicle.

### DESCRIPTION OF THE INVENTION

To this end, the invention relates to a device for filtering air intended to supply an air system of an airborne, rail-bound or automotive transport vehicle.

The filtering device in accordance with the invention is characterized in that it comprises a porous three-dimensional structure comprising at least one portion intended to be in contact with said air to be filtered, referred to as exchange portion, said exchange portion comprising at least one material selected from carbon, a zeolite, a metal-organic structure (more commonly known as metal organic framework, or MOF) and mixtures thereof.

The filtering device in accordance with the invention is configured to capture the pollutants and thus forms a filter for retaining pollutants of the oily aerosol type coming from engines or auxiliary power units (APUs).

The filtering device in accordance with the invention allows the processing of the air which flows at least in said exchange portion of said porous three-dimensional structure by retaining the pollutants of the oily aerosol type coming from, for example, an oil of the Turbonycoil 600 and Aeroshell Oil 2 type of a propulsion engine or an auxiliary engine of the airplane and the olfactive compounds generating unpleasant odors. The air to be decontaminated comprises pollutants present in different liquid, solid or gaseous forms. The olfactive compounds processed by a filtering device in accordance with the invention are for example C5-C9 organic acids, BTEX (benzene, toluene, ethylbenzene and xylene), ethylene/propylene glycol.

Throughout the application, the term “zeolite” refers to a crystallized aluminosilicate having a nanoporous system formed of a network of channels, which may or may not be interconnected, and cages occupied by cations.

The expression “metal organic framework”, also known by the acronym “MOF”, refers to a porous crystalline material composed of one-dimensional, two-dimensional or three-dimensional arrangements of metal ions, most often cations, or of clusters, coordinated by organic ligands. Throughout the text, this material is referred to, without distinction, as “metal-organic structure”, “metal organic framework” or MOF.

The carbon and/or the zeolite and/or the metal organic framework of said porous three-dimensional structure each allow at least the adsorption of the hydrocarbon fractions from pollutants of the oily aerosol type.

Advantageously and in accordance with the invention, the exchange portion is configured to be able to have said flow of air to be filtered pass through it.

According to this advantageous variant, the three-dimensional structure is adsorbent and allows the processing of the air which passes through the exchange portion of said structure and also the distribution of the flow of air uniformly into the flow conduits of the air-conditioning system, which are arranged downstream of the filtering device.

Furthermore, the porous three-dimensional structure of a filter in accordance with the invention does not use a metal catalyst, in particular a catalyst allowing ozone to be reduced.

According to an advantageous embodiment variant of the invention, the exchange portion comprises a mixture of carbon, a zeolite and a metal organic framework.

This association of carbon, a zeolite and an MOF promotes the adsorption capacities of the three-dimensional structure. In particular and according to this variant, the association of the three materials allows selection of the pollutants trapped by each material. In other words, one pollutant may be trapped by the carbon, another pollutant by the MOF and another by the zeolite.

Preferably, the carbon, the zeolite and the metal organic framework of said porous three-dimensional structure also allow the destruction of hydrocarbon fractions from pollutants of the oily aerosol type.

Said filtering device is preferably arranged in an air-conditioning system upstream of an ozone converter so as to prevent the deactivation of said ozone converter, the active phase of which is very sensitive to the pollutants. In fact, the filtering device upstream of the ozone converter allows the retention of the pollutants, which leads to an increase in the service life of the ozone converter and a decrease in maintenance frequency.

According to one variant of the invention, said porous three-dimensional structure is partially or fully formed from at least one material selected from carbon, a zeolite, an MOF and mixtures thereof.

According to this variant, at least one portion of the three-dimensional structure is formed by at least one material selected from carbon, a zeolite, an MOF and mixtures thereof, this portion thus forming the exchange portion in accordance with the invention.

For example, the three-dimensional structure is formed from a stack, structured or non-structured, of pieces each formed from at least one material selected from carbon, a zeolite, an MOF and mixtures thereof.

The porous three-dimensional structure preferably comprises at least one material allowing its physical integrity to be retained at a temperature greater than 150° C., preferably greater than 200° C., preferably greater than 250° C., preferably greater than 270° C., preferably greater than 300° C. This is particularly advantageous in the case of a device for filtering air intended to supply an air system of an airborne transport vehicle.

According to one variant, the volume of said exchange portion corresponds to the volume of said three-dimensional structure so as to form a monolithic whole.

According to this variant, the three-dimensional structure is entirely formed by at least one material selected from carbon, a zeolite, a metal organic framework and mixtures thereof.

According to another variant of the invention, said porous three-dimensional structure comprises an exchange portion comprising at least one material selected from carbon, a zeolite, a metal organic framework and mixtures thereof, and another portion formed from another type of material.

In accordance with the invention, said exchange portion comprises at least one adsorbent material in the form of particles selected from carbon, a zeolite, a metal organic framework and mixtures thereof, said adsorbent particles being bound by a binder, said binder comprising at least one material selected from the group formed of boehmite, hydrated aluminas, transition aluminas and mixtures thereof.

According to another advantageous variant of the invention, the three-dimensional structure is formed of a first material and coated by a coating of a second material comprising at least one adsorbent in the form of particles selected from carbon, a zeolite, a metal organic framework and mixtures thereof, said adsorbent particles being bound by a binder, said binder comprising at least one material selected from the group formed of boehmite, hydrated aluminas, transition aluminas and mixtures thereof, this coating forming said exchange portion.

The presence of a binder comprising boehmite and/or a hydrated alumina and/or a transition alumina advantageously permits good adhesion of the coating on the first material of the three-dimensional structure to be achieved.

Throughout the text, the terms “boehmite” or “aluminum hydroxide oxide” refer to any compound of formula AlO(OH).

Throughout the text, the term “hydrated alumina” refers to any compound of chemical formula (Al₂O₃)ₙ·(H₂O)ₘ, n and m being integers. Within the scope of this description, boehmite is not a hydrated alumina.

Throughout the text, the term “transition alumina” refers to a chi (or khi), kappa, gamma, theta, delta, rho or eta alumina.

According to this variant, the porous three-dimensional structure is surface-functionalized so as to trap pollutants.

According to this variant of the invention, the porous three-dimensional structure is formed of a first material (for example a material selected from ceramics, metals, organic products and mixtures thereof) and is coated, partially or fully, with a layer of material selected from carbon, a zeolite, an MOF and mixtures thereof. This coating thus forms the exchange portion.

Preferably, the material of the three-dimensional structure is selected from alumina, mullite, silica, cordierite, zirconia, silicon carbide, glasses, metals, metal alloys including steels, polytetrafluoroethylene or PTFE, polyether ether ketone or PEEK, polyethylene terephthalate or PET, polyurethanes, polyesters, in particular Ekonol, and mixtures thereof. In one preferred embodiment, the first material is selected from metals, preferably from alloys of iron, chromium and aluminum.

Advantageously and in accordance with the invention, said exchange portion of said porous three-dimensional structure comprises, in mass percent, expressed relative to the total mass of said portion, at least 60% carbon and/or zeolite and/or metal organic framework.

Preferably, the amount of carbon and/or zeolite and/or MOF is greater than 60%, preferably greater than 70%, even greater than 80%, even greater than 90%, in mass percent of the mass of said exchange portion.

Advantageously and in accordance with the invention, said exchange portion of said porous three-dimensional structure has a volume, expressed as a percentage of the total volume of said three-dimensional structure, greater than 10%.

Preferably, the volume of the portion relative to the total volume of the three-dimensional structure is greater than 10%, preferably greater than 20%, preferably greater than 30%, and preferably less than 70%, preferably less than 60%, preferably less than 50%.

Advantageously and in accordance with the invention, the carbon is selected from active carbons, carbon black, lamp black, furnace black, a carbon obtained by pyrolysis of an organic synthesis constituent and mixtures thereof.

According to this variant, at least the exchange portion of the three-dimensional structure comprises carbon, which allows an improvement in the mechanical strength of said three-dimensional structure.

Preferably, the carbon is selected from active carbons and a carbon obtained by pyrolysis of an organic synthesis constituent and mixtures thereof.

Preferably, the coating of the three-dimensional structure is substantially composed of, or is composed of, particles of an adsorbent selected from carbon, a zeolite, a metal organic framework and mixtures thereof, said particles being bound by a binder, said binder comprising, preferably being substantially composed of, preferably being composed of, boehmite and/or a hydrated alumina and/or a transition alumina.

Preferably, the mass ratio of the amount of boehmite and/or hydrated alumina and/or transition alumina to the total amount of boehmite and/or hydrated alumina and/or transition alumina, and of adsorbent is greater than or equal to 3%, preferably greater than or equal to 5%, preferably greater than or equal to 10%, preferably greater than or equal to 15%, and less than or equal to 50%, preferably less than or equal to 40%, preferably less than or equal to 30%, preferably less than or equal to 25%.

In one embodiment, the second material comprises metal organic framework particles bound by a binder, said binder comprising, preferably being substantially composed of, preferably being composed of, boehmite and/or a hydrated alumina.

In one embodiment, the second material consists of zeolite particles bound by a binder, said binder comprising, preferably being substantially composed of, preferably being composed of, a hydrated alumina and/or a transition alumina.

In one embodiment, the second material comprises carbon particles bound by a binder, said binder comprising, preferably being substantially composed of, preferably being composed of, boehmite and/or a hydrated alumina.

In one embodiment, the zeolite has an Si/Al ratio greater than or equal to 1, preferably greater than or equal to 1.5, and preferably the silicon/aluminum (Si/Al) ratio is less than or equal to 30, preferably less than or equal to 25.

According to this variant, the selected zeolite has, preferably, a cage size greater than 2 Å and preferably less than 25 Å, preferably less than 10 Å. The zeolite is hydrophobic and the counter-ion is selected from H, Na and NH₄, preferably from Na and NH₄. A zeolite is a porous material in which the molecules of the pollutant will be trapped by adsorption, preferably by chemisorption.

In one embodiment, the adsorbent is selected from a mixture of zeolites having different Si/Al ratios. Advantageously, the Si/Al ratios can be selected such that said mixture of zeolites adsorbs different types of pollutants.

Advantageously and in accordance with the invention, said metal organic framework is selected from a UIO-66, a UIO-66 (NH₂), a ZIF-67, an MOF-199, a HKUST-1, an MOF-5, an MIL-101 and mixtures thereof, preferably selected from a UIO-66, a HKUST-1 and mixtures thereof.

According to this variant, the MOF comprises a metal center having a coordination greater than 2, preferably greater than 3.

Furthermore, the MOF has heat stability whilst retaining adsorption capacity. Preferably, the MOFs are selected from the MOFs having a thermal resistance greater than 200° C., preferably greater than 250° C., preferably greater than 270° C.

Advantageously and in accordance with the invention, said porous three-dimensional structure has a void volume fraction greater than 30%.

According to this variant, the pressure loss is reduced.

Preferably, the void volume fraction is greater than 40%, preferably greater than 50%, and preferably less than 95%, preferably less than 90%.

The void volume fraction of a porous three-dimensional structure corresponds to the ratio of the volume between the void volume (space not occupied by the material of the three-dimensional structure) and the volume of the three-dimensional structure.

Advantageously and in accordance with the invention, said three-dimensional structure has an open porosity greater than 30%. Preferably, the porous three-dimensional structure has an open porosity greater than 30%, preferably greater than 40%, preferably greater than 50%, preferably greater than 60%, preferably greater than 70%, and less than 95%, preferably less than 90%.

The term “open porosity” means the porosity attributable to all of the accessible pores. According to the classification by the International Union of Pure and Applied Chemistry, 1994, vol. 66, n° 8, pp. 1739-1758, the accessible pores are divided into three categories based on their equivalent diameter:
“macropores” which are the accessible pores having an equivalent diameter greater than 50 nm;
“mesopores” which are the accessible pores having an equivalent diameter between 2 and 50 nm;
“micropores” which are the accessible pores having an equivalent diameter less than 2 nm.

Furthermore, the porous three-dimensional structure preferably has a porosity giving rise to a pressure loss of less than 30 mbar. Preferably, the median equivalent diameter of the macropores is greater than 100 μm, preferably greater than 500 μm and preferably greater than 1 mm, and preferably less than 100 mm, preferably less than 10 mm respectively.

According to one particular embodiment of the invention, said exchange portion of said porous three-dimensional structure comprises several layers, each comprising at least one material selected from carbon, a zeolite, a metal organic framework and mixtures thereof.

According to this variant, the different layers of different adsorbent materials allow the filtration of several types of pollutants using a single filtering device. Furthermore, the presence of several layers allows the adsorption of a number of pollutants at the same time, the selection of the materials of the layers being effected based on the pollutants to be adsorbed. Moreover, this configuration allows one of the layers to trap a pollutant harmful to one of the adsorbent materials of another layer before it comes into contact with said adsorbent material located in this other layer. In other words, this advantageous variant allows the formation of a cascading structure to trap different pollutants.

Advantageously and in accordance with the invention, the porous three-dimensional structure comprises glass fibers and/or a foam.

In accordance with the invention, the porous three-dimensional structure does not comprise a metal catalyst, in particular a catalyst allowing ozone to be reduced.

In particular, the invention aims to trap the pollutants and not destroy them. It is thus possible, for example within the scope of using the filtering device in an air-conditioning system, to change the filter once it is saturated with pollutants.

Preferably, the porous three-dimensional structure has a pore volume greater than 0.03 cm³/g, preferably greater than 0.05 cm³/g, and/or preferably less than 0.5 cm³/g, preferably less than 0.3 cm³/g.

Advantageously, the adsorption capacities of the porous three-dimensional structure are thereby improved. In particular, these features are not suitable for a catalytic system in which diffusion should be avoided.

Advantageously and in accordance with the invention, said filtering device further comprises a metal housing comprising an air inlet, an air outlet and an air flow chamber arranged between said air inlet and said air outlet, said three-dimensional structure being housed in said air flow chamber.

The invention also relates to an air system of an airborne, rail-bound or automotive transport vehicle comprising at least one filtering device in accordance with the invention.

The effects and advantages of a filtering device in accordance with the invention apply mutatis mutandis to an air system in accordance with the invention.

The invention also relates to an air-conditioning system of a cabin of an airborne, rail-bound or automotive transport vehicle comprising at least one filtering device in accordance with the invention.

The effects and advantages of a filtering device in accordance with the invention apply mutatis mutandis to an air-conditioning system in accordance with the invention.

The invention also relates to an airborne transport vehicle comprising a cabin and at least one air-conditioning system of said cabin, characterized in that the air-conditioning system of the cabin is a system in accordance with the invention.

The effects and advantages of an air-conditioning system in accordance with the invention apply mutatis mutandis to an airborne, rail-bound or automotive transport vehicle in accordance with the invention.

The invention also relates to a method for manufacturing a filtering device in accordance with the invention, in which:
a porous three-dimensional structure is selected,
said adsorbent particles are mixed with particles of at least one material selected from the group formed of boehmite, hydrated aluminas, transition aluminas and mixtures thereof,
at least one layer of a coating is formed on at least one portion of the porous three-dimensional structure, said coating comprising said mixture of said adsorbent particles and said particles of at least one material selected from the group formed of boehmite, hydrated aluminas, transition aluminas and mixtures thereof,
said at least partially coated porous three-dimensional structure is subjected to heat treatment at a temperature lower than the degradation temperature of said adsorbent particles or at the lowest degradation temperature of the adsorbents present in the exchange portion and lower than the degradation temperature of the first material forming the three-dimensional structure.

The invention also relates to a method for manufacturing a filtering device in accordance with the invention, comprising at least the following steps:
a step of obtaining a porous three-dimensional structure;
a step of depositing, on said porous three-dimensional structure, a coating comprising at least one material selected from carbon, a zeolite, a metal organic framework and mixtures thereof, this coating forming said exchange portion of said porous three-dimensional structure; and
a step of mounting said porous three-dimensional structure within a housing.

The obtaining step allows the provision of a porous three-dimensional structure according to any technique known from the prior art. In particular, said structure can be obtained by several techniques such as for example 3D printing, ice texturing followed by freeze-drying (or “ice templating”), extrusion, injection, granulation, gelation, covering a sacrificial three-dimensional structure with the material or a precursor of said material (or “soft templating”).

The step of depositing a coating on said porous three-dimensional structure to form the exchange portion can be obtained by any known means.

By way of example, this step can be obtained by dip coating, by infiltration under pressure or by infiltration under vacuum. Preferably, the coating is achieved via dip coating.

A person skilled in the art knows how to adjust the technical features of each step of the implemented method in order to obtain a filtering device comprising a porous three-dimensional structure having one or more of the preferences described above.

The step of mounting the porous three-dimensional structure within a housing allows the filtering device to be finished so as to be able to install it within an air system in accordance with the invention.

The invention also relates to a filtering device, an air system, an air-conditioning system, an airborne transport vehicle and a method for manufacturing a filtering device which are characterized in combination by all or some of the features mentioned above or below.

### LIST OF FIGURES

Other aims, features and advantages of the invention will become apparent upon reading the following description given solely in a non-limiting way and which makes reference to the attached figures in which:

FIG. 1 is a schematic cross-sectional view of a filtering device in accordance with one embodiment of the invention, and

FIG. 2 is a schematic view of an air-conditioning system in accordance with one embodiment of the invention,

FIG. 3 is a schematic view of a method for manufacturing a filtering device in accordance with one embodiment of the invention.

### DETAILED DESCRIPTION OF AN EMBODIMENT OF THE INVENTION

In the figures, for the sake of illustration and clarity, scales and proportions have not been strictly respected. Throughout the detailed description which follows with reference to the figures, unless stated to the contrary, each element of the filtering device is described as it is housed in a flow chamber of an air-conditioning system. Furthermore, identical, similar or analogous elements are designated by the same reference signs in all the figures.

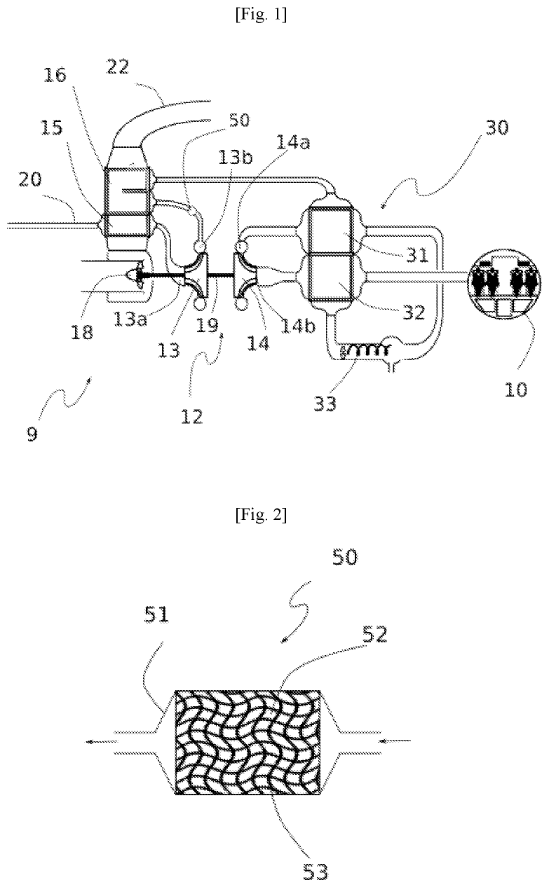

FIG. 1 schematically illustrates an air-conditioning system of a cabin of an airplane comprising a filtering device 50 in accordance with the invention.

The air-conditioning system 9 in accordance with the embodiment of FIG. 1 comprises an air-cycle turbomachine 12 comprising a compressor 13 and an expansion turbine 14 mechanically coupled together by a mechanical shaft 19. This mechanical shaft 19 also drives a fan 18.

The compressor 13 comprises an air inlet 13a connected to a device for drawing air from an air source, not shown in the figures for reasons of clarity, via a primary cooling exchanger, also referred to as PHX (primary heat exchanger) 15, and a conduit 20 fluidically connecting the air-drawing device and the PHX 15.

In other words, the air coming from the air-drawing device, which is for example an air-drawing device on a compressor of a propulsion engine of the airplane or an air-drawing device on a compressor of an auxiliary engine of the airplane, supplies the compressor 13 of the air-cycle turbomachine 12 after passing into a PHX 15. This PHX 15 comprises a primary circuit formed by the air supplied by the air-drawing device via the conduit 20 and a secondary circuit supplied with air at dynamic pressure which flows in a flow channel 22 for dynamic air, referred to hereinafter as dynamic air channel.

The flow of dynamic air in the dynamic air channel 22 is ensured by the fan 18 mounted on the shaft 19 of the air-cycle turbomachine which extends into the dynamic air channel 22. According to other variants, the fan 18 can be separate from the shaft 19 and rotationally driven by an independent electric motor.

The compressor 13 also comprises an air outlet 13b fluidically connected to a main cooling exchanger, also referred to by the acronym MHX (main heat exchanger) 16 which is arranged in the flow channel 22 for dynamic air drawn from outside of the airplane.

The air which flows from the outlet 13b of the compressor to the inlet of the MHX passes through the filtering device 50 in accordance with the invention so as to purify the air intended to supply the cabin 10. This device 50 will be described in more detail hereinafter.

Nevertheless, it should be noted that the filtering device 50 can be arranged elsewhere within the air-conditioning system, e.g. on the conduit 20 upstream of the PHX 15. In this case, the device 50 filters the air coming from the air-drawing device, more commonly known as bleed air.

Preferably, the filtering device 50 is arranged upstream of an ozone converter (more commonly known as the acronym OZC) which is not shown in the figures, which allows the deactivation of this ozone converter to be prevented.

The expansion turbine 14 of the air-cycle turbomachine 12 comprises an air inlet 14a supplied with the air coming from the MHX 16 after passing through a water extraction loop 30 (which comprises, in a conventional manner, a heater 31, a condenser 32 and a water extractor 33), and an air outlet 14b connected to a cabin 10, in order to be able to supply pressure-controlled and temperature-controlled air.

FIG. 2 schematically illustrates one embodiment of the filtering device 50.

The device comprises a housing 51, a three-dimensional structure 52 and an exchange portion 53 comprising at least one material selected from carbon, a zeolite, a metal organic framework and mixtures thereof.

The housing 51 can be of any known type. According to one variant, the housing 51 is a cylinder of revolution to be able to be arranged within a cylindrical conduit of an air-conditioning system.

The three-dimensional structure 52 is porous, i.e. it has an open porosity greater than 30%.

The exchange portion 53 is, according to the illustrated embodiment, formed by a coating applied onto the three-dimensional mesh structure, which structure is itself ceramic. As indicated above, this three-dimensional mesh structure can be made from a different material.

According to another embodiment, the three-dimensional mesh structure 52 is made directly from a material selected from carbon, a zeolite, a metal organic framework and mixtures thereof.

Regardless of the design of the mesh structure, the carbon can be selected from active carbons, carbon black, lamp black, furnace black, a carbon obtained by pyrolysis of an organic synthesis constituent and mixtures thereof.

The zeolite has, for example and preferably, an Si/Al ratio greater than or equal to 1, preferably greater than or equal to 1.5, and preferably the silicon/aluminum (Si/Al) ratio is less than or equal to 30, preferably less than or equal to 25.

The metal organic framework (MOF) is, for example and preferably, selected from UIO-66, UIO-66 (NH₂), ZIF-67, MOF-199, HKUST-1, MOF-5, MIL-101 and mixtures thereof.

The arrows in FIG. 2 schematically illustrate the direction of passage of the air in the filtering device.

Within the scope of use in the air-conditioning system of FIG. 1, the volatile organic compounds, such as toluene, carboxylic acids, acetaldehyde and propylene glycol, are trapped (chisorbed) by the filter. The flow rate of air passing through the filter is for example between 250 and 700 g/s and the temperature of the device can vary between 12° and 270° C. at a pressure between 1 and 4 bar.

According to one embodiment of the invention, the three-dimensional structure 52 is formed from a first material selected from ceramics, metals, organic products (polymers) and mixtures thereof. Preferably, the first material is selected from the group formed of alumina, mullite, silica, cordierite, zirconia, silicon carbide, glasses, metals, metal alloys including steels, polytetrafluoroethylene or PTFE, polyether ether ketone or PEEK, polyethylene terephthalate or PET, polyurethanes, polyesters, in particular Ekonol, and mixtures thereof. In one preferred embodiment, the first material is selected from metals, preferably from alloys of iron, chromium and aluminum.

This structure is then coated with a coating of a second material comprising at least particles of an adsorbent selected from the group formed of carbons, zeolites, metal organic frameworks and mixtures thereof, said particles being bound by a binder, said binder comprising at least one material selected from the group formed of boehmite, hydrated aluminas, transition aluminas and mixtures thereof. Preferably, said second material is substantially composed of, or is composed of, particles of an adsorbent selected from the group formed of carbons, zeolites, metal organic frameworks and mixtures thereof, said particles being bound by a binder, said binder comprising, preferably being substantially composed of, preferably being composed of, boehmite and/or a hydrated alumina and/or a transition alumina.

As indicated above, preferably said second material comprises a mixture of at least two adsorbents selected from the group formed of carbons, zeolites and metal organic frameworks. In one embodiment, said second material comprises a mixture of zeolites having different Si/Al ratios. In one embodiment, said second material comprises a mixture of carbon, a zeolite and a metal organic framework.

In this embodiment, the porous three-dimensional structure 52 can be obtained, for example, by 3D printing, ice texturing followed by freeze-drying (or “ice templating”), extrusion, injection, granulation, gelation, covering a sacrificial three-dimensional structure with the material or a precursor of said material (or “soft templating”), corrugation of a metal sheet, or any equivalent means.

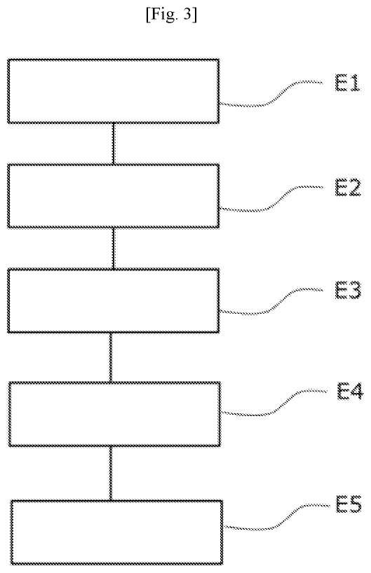

FIG. 3 schematically illustrates a method for manufacturing a filtering device in accordance with this embodiment.

In step E1, the porous three-dimensional structure is obtained, for example, by 3D printing, ice texturing followed by freeze-drying (or “ice templating”), extrusion, injection, granulation, gelation, covering a sacrificial three-dimensional structure with the material or a precursor of said material (or “soft templating”) or any equivalent means.

In step E2, a mixture is produced of at least one adsorbent powder selected from carbon, a zeolite, a metal organic framework and mixtures thereof, and a boehmite powder, the amount of boehmite being such that the mass ratio of the amount of boehmite to the total amount of boehmite and adsorbent powder(s) is greater than or equal to 3%, preferably greater than or equal to 5%, preferably greater than or equal to 10%, preferably greater than or equal to 15%, and less than or equal to 50%, preferably less than or equal to 40%, preferably less than or equal to 30%, preferably less than or equal to 25%.

Preferably, the median size of the adsorbent powder(s) is greater than 0.1 μm and/or less than 100 μm.

The adsorbent powder(s) and the boehmite powder can be provided in the form of a suspension or any other form comprising said powder(s).

In a preferred embodiment, the boehmite of the mixture is peptized. Peptization of the boehmite is a process well known to a person skilled in the art. It consists of the dispersion of a boehmite powder in an aqueous acid solution so as to result in at least partial dissolution of the boehmite particles. Advantageously, the peptization of the boehmite in the mixture allows the quantity of boehmite in said mixture to be increased and/or the viscosity of said mixture to be reduced.

The boehmite can be peptized by introducing the boehmite powder into water so as to obtain a suspension, then adjusting the pH of said suspension to a value preferably greater than 1, preferably greater than 2, and/or less than 7, preferably less than 6, preferably less than 5.

In a preferred embodiment, the pH is adjusted by the addition of an acid, preferably selected from nitric acid, formic acid, maleic acid, oxalic acid and mixtures thereof.

Further preferably, the boehmite of the feedstock is peptized prior to the introduction of the adsorbent powder(s).

As is well known to a person skilled in the art, the mixture can comprise, in addition to the boehmite and adsorbent powder(s), a solvent and/or an organic binder and/or a plasticizer and/or a lubricant, the type and amounts of which are adapted to the coating-forming technique implemented in step E3.

Preferably, the solvent is water. The amount of solvent is adapted to the coating-forming technique implemented in step E3.

The mixture optionally contains an organic binder, preferably in an amount between 0.1% and 10%, preferably between 0.2% and 2% by mass based on the mass of the boehmite and adsorbent powder(s) of the mixture.

All of the organic binders conventionally used for producing coatings can be used, for example polyvinyl alcohol (PVA) or polyethylene glycol (PEG), starch, xanthan gum, methyl cellulose, ethyl cellulose, carboxymethyl cellulose, carboxyethyl cellulose, hydroxyethyl cellulose, methyl stearate, ethyl stearate, waxes, polyolefins, polyolefin oxides, glycerin, propionic acid, maleic acid, benzyl alcohol, isopropanol, butyl alcohol, a dispersion of paraffin and polyethylene, and mixtures thereof.

The mixture optionally contains a plasticizer, facilitating the formation of the coating.

Preferably, the amount of plasticizer is between 1% and 10%, preferably between 1% and 5% by mass based on the mass of the boehmite and adsorbent powder(s) of the mixture. The plasticizer can be a binder.

All of the plasticizers conventionally used for producing coatings can be used, for example polyethylene glycol, polyolefin oxides, hydrogenated oils, alcohols, in particular glycerol and glycol, esters, starch and mixtures thereof.

The mixture optionally contains a lubricant, also facilitating the formation of the coating.

Preferably, the amount of lubricant is between 1% and 10%, preferably between 1% and 5% by mass based on the mass of the boehmite and adsorbent powder(s) of the mixture.

All of the lubricants conventionally used for producing coatings can be used, for example Vaseline and/or waxes.

Preferably, the boehmite, the solvent, preferably water, and the acid are mixed so as to obtain an intimate mixture. Then, the other ingredients, in particular the adsorbent powder(s), the optional binders, lubricants, plasticizers, are added under agitation. The amount of solvent, preferably water, can be added gradually, in an amount determined based on the coating-forming technique used in step E3.

The different ingredients can be mixed following any technique known to a person skilled in the art, for example in a mixer, a Turbula mixer, a jar mill with balls, preferably aluminum balls.

The total mixing time is preferably greater than 12 hours, preferably greater than 20 hours, preferably greater than 24 hours, and preferably less than 72 hours, preferably less than 60 hours.

In step E3, the mixture obtained at the end of step E2 is applied, in the form of a coating layer, onto at least one portion of the porous three-dimensional structure. This layer comprises at least one material selected from carbon, a zeolite, a metal organic framework and mixtures thereof.

This layer can be obtained by dip coating, by infiltration under pressure or by infiltration under vacuum.

In step E4, the at least partially coated porous three-dimensional structure obtained at the end of step E3 is subjected to heat treatment at a temperature lower than the degradation temperature of the adsorbent present in the exchange portion or at the lowest degradation temperature of the adsorbents present in the exchange portion and lower than the degradation temperature of the first material forming the three-dimensional structure.

A person skilled in the art knows how to determine the degradation temperature of the adsorbent in question. For example, the degradation temperature of a metal organic framework or of a zeolite is the starting temperature of the last mass loss peak of said metal organic framework or said zeolite (in other words, the peak at the highest temperatures), as observed using thermogravimetric analysis (TGA), and the degradation temperature of the carbon can be determined by temperature programmed oxidation, or TPO.

A person skilled in the art also knows how to determine the degradation temperature of the first material forming the three-dimensional structure.

Preferably, the maximum temperature reached during the heat treatment cycle is greater than the lowest degradation temperature of the adsorbent(s) and of the first material forming the three-dimensional structure minus 150° C., preferably greater than the lowest degradation temperature of the adsorbent(s) and of the first material forming the three-dimensional structure minus 125° C., preferably greater than the lowest degradation temperature of the adsorbent(s) and of the first material forming the three-dimensional structure minus 100° C., and preferably less than the lowest degradation temperature of the adsorbent(s) and of the first material forming the three-dimensional structure minus 5° C., preferably less than the lowest degradation temperature of the adsorbent(s) and of the first material forming the three-dimensional structure minus 10° C.

Preferably, whilst satisfying the conditions described immediately above, if the degradation temperature of the absorbent(s) allows it, the maximum temperature reached during the heat treatment cycle is greater than 150° C., preferably greater than 180° C., preferably greater than 200° C., and preferably less than or equal to 800° C., preferably less than or equal to 700° C.

Further preferably, the heat treatment cycle has a plateau at said maximum temperature reached. The hold time at the plateau is preferably greater than 0.5 hours, preferably greater than 1 hour, preferably greater than 2 hours, and preferably less than 10 hours, preferably less than 5 hours, preferably less than 4 hours.

The heat treatment is preferably performed in air, at atmospheric pressure.

Finally, in step E5, the three-dimensional structure is arranged within a housing, for example a metal housing, and mounted thereon by any type of mounting means (adhesive, embedding, screwing, etc.).

The following non-limiting examples are provided so as to illustrate the invention.

### Measuring Protocol

The adsorption capacity of toluene of the examples is measured in a conventional manner from a breakthrough curve measured at a temperature equal to 200° C. on samples representative of a coated three-dimensional structure, in a glass reactor having an inner diameter equal to 30 mm, with a gas flow composed of helium containing 100 ppm of toluene, injected at a flow rate of 6 liters per hour, said samples being previously dried at 50° C. for 15 minutes.

The result is expressed in mg of toluene per gram of adsorbent present in the sample.

### Manufacturing Protocol

The following raw materials were used for producing the examples:

for examples 1 to 4, a metal monolithic three-dimensional structure made of an aluminum and chromium and iron alloy, having:
a height equal to 2.54 cm,
an inner diameter equal to 2.54 cm,
a channel density per square inch equal to 300 (in other words, 300 channels per square inch (CPSI)), the channels being trapezoidal in shape,
arranged in a band having an outer diameter equal to 2.8 cm,
for examples 1 and 2, a 3A zeolite powder having an Si/Al ratio equal to 2.6, a counter-ion Na, a median particle size equal to 4.4 μm,
for examples 3 and 4, a UiO-66 metal organic framework powder, sold by the company SIGMA ALDRICH®, having a median size equal to 1.3 μm,
a DISPERAL P2® boehmite powder, sold by the company SASOL®, for examples 2 and 4,
an aqueous solution of nitric acid at 70% by mass, sold by the company SIGMA ALDRICH®, for examples 2 and 4,
polyvinyl alcohol.

### Example 1

The three-dimensional structure of example 1, not part of the invention, was obtained in the following manner. 80 g of 3A zeolite powder and 8.57 g of polyvinyl alcohol in aqueous solution at 35% by mass are mixed in 300 g of distilled water using a blade agitator. The mixture is kept under agitation for 1 hour. Then, the obtained mixture is milled in a rotating jar mill using aluminum balls for a period of time equal to 48 hours. The mixture is thus in the form of a homogeneous suspension.

The metal monolithic three-dimensional structure is thus fully immersed in said suspension for 30 seconds, and then gradually removed from said suspension and placed on a screen cloth. The excess suspension is then removed by blowing, and the coated three-dimensional structure is placed in a roll dryer, in air, at room temperature, in which it is rotated for 6 hours, allowing the coating to be dried whilst ensuring good homogeneity of thickness of said coating. The coated three-dimensional structure is then removed from the roll dryer. Then, said coated three-dimensional structure is immersed a second time, blown a second time and dried a second time under the same conditions as those described above. The immersion-blowing-drying cycle is repeated another 3 times so that the metal monolithic three-dimensional structure has passed through a total of 5 immersion-blowing-drying cycles. The three-dimensional structure thus obtained is placed in a furnace, in air, then brought to 700° C., with a temperature-increase rate equal to 5° C./minute, kept at 700° C. for 2 hours, then removed from the furnace.

### Example 2

The three-dimensional structure of example 2, in accordance with the invention, was obtained in the following manner. 20 g of DISPERAL P2® boehmite are mixed with 1.4 g of an aqueous solution of nitric acid at 70% by mass, and 100 ml of distilled water using a blade agitator. The mixture is kept under agitation for 1 hour. The agitation is then stopped and 80 g of 3A zeolite powder, 8.57 g of polyvinyl alcohol in aqueous solution at 35% by mass and 375 g of distilled water are added to the mixture. The mixture is milled in a rotating jar mill using aluminum balls for a period of time equal to 48 hours. The mixture is thus in the form of a homogeneous suspension.

The metal monolithic three-dimensional structure is thus fully immersed in said suspension for 30 seconds, and then gradually removed from said suspension and placed on a screen cloth. The excess suspension is then removed by blowing, and the coated three-dimensional structure is placed in a roll dryer, at room temperature, in which it is rotated for 6 hours. The coated three-dimensional structure is then removed from the roll dryer. Then, said coated three-dimensional structure is immersed a second time, blown a second time and dried a second time under the same conditions as those described above. The immersion-blowing-drying cycle is repeated another 3 times so that the metal monolithic three-dimensional structure has passed through a total of 5 immersion-blowing-drying cycles. The three-dimensional structure thus obtained is placed in a furnace, in air, then brought to 700° C., with a temperature-increase rate equal to 5° C./minute, kept at 700° C. for 2 hours, then removed from the furnace.

### Example 3

The three-dimensional structure of example 3, not part of the invention, was obtained in the following manner. 80 g of UiO-66 metal organic framework powder and 8.57 g of polyvinyl alcohol in aqueous solution at 35% by mass are mixed in 300 g of distilled water using a blade agitator. The mixture is kept under agitation for 1 hour. Then, the obtained mixture is milled in a rotating jar mill using aluminum balls for a period of time equal to 48 hours. The mixture is thus in the form of a homogeneous suspension.

The metal monolithic three-dimensional structure is thus fully immersed in said suspension for 30 seconds, and then gradually removed from said suspension and placed on a screen cloth. The excess suspension is then removed by blowing, and the coated three-dimensional structure is placed in a roll dryer, at room temperature, in which it is rotated for 6 hours. The coated three-dimensional structure is then removed from the roll dryer. Then, said coated three-dimensional structure is immersed a second time, blown a second time and dried a second time under the same conditions as those described above. The immersion-blowing-drying cycle is repeated another 3 times so that the metal monolithic three-dimensional structure has passed through a total of 5 immersion-blowing-drying cycles. The three-dimensional structure thus obtained is placed in a furnace, in air, then brought to 250° C., with a temperature-increase rate equal to 5° C./minute, kept at 250° C. for 3 hours, then removed from the furnace.

### Example 4

The three-dimensional structure of example 4, in accordance with the invention, was obtained in the following manner. 20 g of DISPERAL P2® boehmite are mixed with 1.4 g of an aqueous solution of nitric acid at 70% by mass, and 100 ml of distilled water using a blade agitator. The mixture is kept under agitation for 1 hour. The agitation is then stopped and 80 g of UiO-66 metal organic framework powder, 8.57 g of polyvinyl alcohol in aqueous solution at 35% by mass and 375 g of distilled water are added to the mixture. The mixture is milled in a rotating jar mill using aluminum balls for a period of time equal to 48 hours. The mixture is thus in the form of a homogeneous suspension.

The metal monolithic three-dimensional structure is thus fully immersed in said suspension for 30 seconds, and then gradually removed from said suspension and placed on a screen cloth. The excess suspension is then removed by blowing, and the coated three-dimensional structure is placed in a roll dryer, at room temperature, in which it is rotated for 6 hours. The coated three-dimensional structure is then removed from the roll dryer. Then, said coated three-dimensional structure is immersed a second time, blown a second time and dried a second time under the same conditions as those described above. The immersion-blowing-drying cycle is repeated another 3 times so that the metal monolithic three-dimensional structure has passed through a total of 5 immersion-blowing-drying cycles. The three-dimensional structure thus obtained is placed in a furnace, in air, then brought to 250° C., with a temperature-increase rate equal to 5° C./minute, kept at 250° C. for 3 hours, then removed from the furnace.

Table 1 below summarizes the results obtained. The mass percent of boehmite in the second column corresponds to the percentage of the mass of boehmite relative to the sum between the total mass of boehmite and the total mass of adsorbent powder. The mass percent of the coating in the fourth column corresponds to the percentage of the mass of coating relative to the total mass of the coated three-dimensional structure.

TABLE 1

| | Amount of | | | |
|---|---|---|---|---|
| | boehmite (in % | Adhesion of | | |
| | based on the | the coating to | Amount of coating | |
| | amount of | the surface of | after heat treatment, | Adsorption |
| | boehmite + | the three- | in % by mass based | capacity of |
| | adsorbent | dimensional | on the coated three- | toluene (mg/g |
| Example | powder) | structure | dimensional structure | of adsorbent) |
| 1(*) | 0 | No | The coating has not | Not |
| | | | adhered to the | determined |
| | | | surface of the metal | |
| | | | monolithic three- | |
| | | | dimensional structure | |
| 2 | 20 | Yes | 7 | 26.1 mg/g |
| 3(*) | 0 | No | The coating has not | Not |
| | | | adhered to the | determined |
| | | | surface of the metal | |
| | | | monolithic three- | |
| | | | dimensional structure | |
| 4 | 20 | Yes | 7 | 12 mg/g |

(*)not part of the invention

A comparison of example 1, not part of the invention, and example 2 in accordance with the invention shows the impact of the presence of boehmite in the suspension allowing the coating to be obtained: in example 1, the coating formed of 3A zeolite particles does not adhere to the metal monolithic three-dimensional structure, contrary to example 2, in which the coating formed of 3A zeolite particles and transition alumina, mainly formed of gamma alumina, has good adhesion to the metal monolithic three-dimensional structure.

A comparison of example 3, not part of the invention, and example 4 in accordance with the invention also shows the impact of the presence of boehmite in the suspension allowing the coating to be obtained: in example 3, the coating formed of UiO-66 metal organic framework particles does not adhere to the metal monolithic three-dimensional structure, contrary to example 4, in which the coating formed of UiO-66 metal organic framework particles and boehmite and hydrated alumina has good adhesion to the metal monolithic three-dimensional structure.

The coated three-dimensional structures of examples 2 and 4 have an adsorption capacity of toluene equal to 26.1 and 12 mg/g of adsorbent respectively.

Of course, the invention is not limited to the described embodiments which are provided solely for the purposes of illustration.

1. A device for filtering air intended to supply an air system of an airborne, rail-bound or automotive transport vehicle, comprising a porous three-dimensional structure comprising at least one portion intended to be in contact with said air to be filtered, referred to as exchange portion, said exchange portion comprising at least one adsorbent material in the form of particles selected from carbon, a zeolite, a metal organic framework and mixtures thereof, said adsorbent material in the form of particles comprising at least one zeolite having an Si/Al ratio greater than or equal to 1 and less than or equal to 25, said adsorbent particles being bound by a binder, said binder comprising at least one material selected from the group formed of boehmite, hydrated aluminas, transition aluminas and mixtures thereof.

2. The filtering device as claimed in claim 1, wherein said exchange portion is configured to be able to have the flow of air to be filtered pass through the exchange portion.

3. The filtering device as claimed in claim 1, wherein said three-dimensional structure is formed of a first material and coated by a coating of a second material comprising said adsorbent material in the form of particles and said binder, this coating forming said exchange portion.

4. The filtering device as claimed in claim 1, wherein said exchange portion comprises, in mass percent, expressed relative to the total mass of said portion, at least 60% zeolite.

5. The filtering device as claimed in claim 1, wherein the mass ratio of the amount of boehmite and/or hydrated alumina and/or transition alumina to the total amount of boehmite and/or hydrated alumina and/or transition alumina, and adsorbent is greater than or equal to 10%, and less than or equal to 30%.

6. The filtering device as claimed in claim 1, wherein the carbon is selected from the group consisting of active carbons, carbon black, lamp black, furnace black, a carbon obtained by pyrolysis of an organic synthesis constituent and mixtures thereof.

7. The filtering device as claimed in claim 1, wherein said zeolite has an Si/Al ratio greater than or equal to 1.5.

8. The filtering device as claimed in claim 1, wherein said metal organic framework is selected from the group consisting of UIO-66, UIO-66 (NH₂), ZIF-67, MOF-199, HKUST-1, MOF-5, MIL-101 and mixtures thereof.

9. The filtering device as claimed in claim 1, wherein said porous three-dimensional structure has a void volume fraction greater than 30%.

10. The filtering device as claimed in claim 1, wherein said exchange portion comprises several layers, each comprising at least one compound selected from the group consisting of carbon, a zeolite, a metal organic framework and mixtures thereof.

11. The filtering device as claimed in claim 1, wherein it further comprises a metal housing comprising an air inlet, an air outlet and an air flow chamber arranged between said air inlet and said air outlet, said porous three-dimensional structure being housed in said air flow chamber.

12. Air-conditioning system of a cabin of an airborne, rail-bound or automotive transport vehicle comprising at least one filtering device comprising a porous three-dimensional structure comprising at least one portion intended to be in contact with said air to be filtered, referred to as exchange portion, said exchange portion comprising at least one adsorbent material in the form of particles selected from carbon, a zeolite, a metal organic framework and mixtures thereof, said adsorbent material in the form of particles comprising at least one zeolite having an Si/Al ratio greater than or equal to 1 and less than or equal to 25, said adsorbent particles being bound by a binder, said binder comprising at least one material selected from the group formed of boehmite, hydrated aluminas, transition aluminas and mixtures thereof.

13. Airborne transport vehicle comprising a cabin and at least one air-conditioning system of said cabin, wherein the air-conditioning system of the cabin is an air-conditioning system as claimed in claim 12.

14. A method for manufacturing a filtering device comprising a porous three-dimensional structure comprising at least one portion intended to be in contact with said air to be filtered, referred to as exchange portion, said exchange portion comprising at least one adsorbent material in the form of particles selected from carbon, a zeolite, a metal organic framework and mixtures thereof, said adsorbent material in the form of particles comprising at least one zeolite having an Si/Al ratio greater than or equal to 1 and less than or equal to 25, said adsorbent particles being bound by a binder, said binder comprising at least one material selected from the group formed of boehmite, hydrated aluminas, transition aluminas and mixtures thereof, in which:
a porous three-dimensional structure is selected,
said adsorbent particles are mixed with particles of at least one material selected from the group formed of boehmite, hydrated aluminas, transition aluminas and mixtures thereof,
at least one layer of a coating is formed on at least one portion of the porous three-dimensional structure, said coating comprising said mixture of said adsorbent particles and said particles of at least one material selected from the group formed of boehmite, hydrated aluminas, transition aluminas and mixtures thereof,
said at least partially coated porous three-dimensional structure is subjected to heat treatment at a temperature lower than the degradation temperature of said adsorbent particles or at the lowest degradation temperature of the adsorbents present in the exchange portion and lower than the degradation temperature of the first material forming the three-dimensional structure.
